(19) United States
(12) Patent Application Publication
(10) Pub. No.: US 2026/0338008 A1
(43) Pub. Date: Oct. 29, 2026

(54) MOTOR VEHICLE LOCK

(71) Applicant: Kiekert Aktiengesellschaft, Heiligenhaus (DE)

(72) Inventors: Tobias STEFFEN, Essen (DE); Viktor KIMEL, Essen (DE); Carsten FUCHS, Essen (DE)

(73) Assignee: Kiekert Aktiengesellschaft, Heiligenhaus (DE)

(21) Appl. No.: 19/103,952

(22) PCT Filed: Aug. 15, 2023
(86) PCT No.: PCT/DE2023/100597

§ 371 Date: Feb. 14, 2025

(30) Foreign Application Priority Data
Aug. 26, 2022 (DE) 10 2022 121 655.1

(51) Int. Cl. E05B 81/50; E05B 81/06; E05B 81/16; E05B 81/30; E05B 81/34; E05B 81/62

(52) U.S. Cl. CPC E05B 81/50; E05B 81/06; E05B 81/16; E05B 81/30; E05B 81/34; E05B 81/62

(57) ABSTRACT

The invention relates to a motor vehicle lock, in particular a motor vehicle door lock, which is equipped with a locking mechanism (1, 2) substantially comprising a rotary latch (1) and a pawl (2). Furthermore, an electromotive drive (8, 9, 10) having an electric motor (8) is provided, wherein, by means of an actuator (10), the electromotive drive (8, 9, 10) selectively urges a coupling element (7) of an operating lever chain (3, 4, 5, 6, 7) into the “engaged” and “disengaged” positions. According to the invention, the actuator (10) is assigned a blocking element (11) which ensures temporary blocking of the actuator (10) in order to switch off the electric motor (8) following an actuator movement, and subsequent reversal of the actuator (10).

The invention relates to a motor vehicle lock, in particular a motor vehicle door lock, with a locking mechanism consisting substantially of a rotary latch and a pawl, and with an electromotive drive with an electric motor, wherein, by means of an actuator, the electromotive drive selectively urges a coupling element of an operating lever chain into the “engaged” and “disengaged” positions.

Motor vehicle locks and in particular motor vehicle door locks of the design described above are used in different variants and a variety of positions in and on a motor vehicle. In fact, this includes tailgate locks, hood locks, fuel filler flap locks and also seat locks. In general, however, the motor vehicle locks in question and in particular motor vehicle door locks are implemented on motor vehicle side doors.

In this place, electric motor opening drives are often used, which are increasingly being used for comfort and acoustic reasons. With the help of such electromotive opening drives, the locking mechanism consisting of the rotary latch and pawl in the closed position can be opened by lifting the pawl from its locking engagement with the rotary latch with the help of the electromotive drive. This causes the rotary latch to open with the aid of a spring and releases a previously caught locking bolt and thus the associated motor vehicle door.

However, in the event of a crash or a failure of the electrical power supply to the electromotive drive for opening the locking mechanism, emergency measures or a so-called emergency operation or even an emergency opening are required. To do this, the procedure is often such that in the event of an emergency opening or in the event of a crash, the operating lever chain is moved to its “unlocked” position so that, for example, rescue personnel can open an associated motor vehicle door. This process is often referred to as “temporary crash redundancy (TCR)” because the operating lever chain is typically mechanically closed for emergency opening and then often returns to its open and thus locked state.

This means that the operating lever chain in question is generally open during normal operation and is thus “locked”, so that the locking mechanism cannot be acted on using the operating lever chain during normal operation. Rather, in such a case, the electromotive drive ensures the electromotive opening. However, if emergency operation and consequently an emergency opening occurs, for example in the event of a crash, the operating lever chain is closed mechanically. This is generally ensured by the coupling element. In such a case, it is transferred to its “engaged” position, which corresponds to the closed configuration of the operating lever chain. As a result, arriving rescue personnel can, for example, open the locking mechanism mechanically via the operating lever chain that is closed in this way. If, however, the coupling element is “disengaged” during normal operation and the operating lever chain is consequently “locked,” the operating lever chain cannot be caused to open the locking mechanism when acted upon.

Such an approach has proven to be fundamentally successful, as made clear by the generic document DE 10 2019 132 764 A1. There, an electromotive drive is implemented, which acts on a safety element. With the help of the safety element, a safety device can be controlled to assume its safety position. In addition to this electromotive drive, an electromotive opening drive is additionally implemented. This leads to a structurally complex design because such electromotive drives are costly.

In contrast, the invention addresses the technical problem of realizing a structural simplification compared to the prior art and, in particular, of creating the possibility of enabling the electromotive drive to perform additional functions in addition to acting on the coupling element.

To solve this technical problem, a generic motor vehicle lock and in particular a motor vehicle door lock is characterized within the scope of the invention in that the actuator is assigned a blocking element which ensures temporary blocking of the actuator in order to switch off the electric motor following an actuator movement, and subsequent reversal of the actuator and thus of the electromotive opening drive.

The implemented blocking element makes it easy to distinguish and separate individual functional states and corresponding actuator movements that can be realized with the help of the electromotive drive. In fact, the motor vehicle lock in question generally and during normal operation assumes a locked state in which the associated operating lever chain is open. In this case, the actuator ensures that the coupling element of the operating lever chain assumes its “disengaged” position. The operating lever chain is open.

If, for example, the electromotive drive in question is additionally also intended to be used to open the locking mechanism using an electric motor, this generally requires unlocking first. For this purpose, the actuator may be acted on by the electromotive drive starting from a basic position or a spring may be used to pre-tension the actuator in the “unlocked” direction of the operating lever chain.

As soon as the actuator and thus the operating lever chain have assumed the “unlocked” state and consequently the coupling element has been “engaged” after previously assuming its “disengaged” state in normal operation, an actuator movement can now be carried out to open the locking mechanism by electric motor. This may be ensured, for example, by the signal of a sensor which informs a control unit acting on the electromotive drive that the actuator and thus the operating lever chain has assumed its “unlocked” position. The sensor in question can also be assigned to the coupling element which has been transferred from its “disengaged” functional position to the “engaged” position during normal operation.

During this actuator movement following the “unlocked” state, the locking mechanism is now opened by an electric motor. For this purpose, the electromotive drive with electric motor generally acts on the actuator in the opposite direction to the actuation direction that was used to assume the “unlocked” position. This actuator movement of the electromotive drive with electric motor and consequently also of the actuator is continued until the additionally provided blocking element ensures the temporary blocking of the actuator. As soon as the corresponding position of the actuator has been reached, the blocking of the actuator by the blocking element, which usually interacts directly with the actuator, ensures that the actuator is held and blocked. The same applies to the electric motor that acts on the actuator, which consequently experiences a blocking or “runs into a block.”

Since the electric motor or the control unit is typically assigned a sensor which, for example, detects an increased current consumption of the electric motor during such a blocking movement, this process of blocking the actuator by the incoming blocking element leads overall to the electric motor being switched off.

As a result of this shutdown of the electric motor, a spring assigned to the electromotive drive can ensure that the actuator is reversed and at the same time the blocking element swings out compared to its blocking position or leaves the blocking position. At the end of this process, the electromotive drive returns to its basic position. The blocking of the actuator is limited in time, i.e., temporary, namely only as long as the blocking element is in its blocking position in relation to the actuator.

During the actuator movement for the electromotive opening of the locking mechanism in the example case, the coupling element is generally and simultaneously acted upon by the actuator and changes from its “engaged” position to the “disengaged” position. As a result, at the end of the actuator movement, the operating lever chain returns to the “locked” position it was in at the beginning.

Overall, the interaction between the actuator and the blocking element enables a perfect functional separation when the actuator is urged on the one hand to unlock the operating lever chain and on the other hand to open it using an electric motor. All of this is achieved by taking into account a simple and compact design, because only the actuator and the blocking element interact with each other. These are the main advantages.

According to a further advantageous embodiment, the blocking element as well as the actuator are each mounted so as to be rotatable about an associated axis. Both axes are predominantly arranged parallel to each other and spaced apart from each other. In addition, the topological design is correctly selected so that the blocking element is arranged adjacent to a blocking contour of the actuator. The blocking element is generally designed as a blocking lever with at least a blocking arm and a control arm.

The blocking arm advantageously has a pin that interacts with a contour of the actuator. Due to the interaction between the pin and the contour, the blocking lever or the blocking element can interact directly with the actuator or its contour in order to ensure the previously described temporary blocking of the actuator for switching off the electric motor. The contour in question is usually designed as a U-shaped web. The pin arranged on the blocking arm of the blocking lever can swing into the U-shaped web in question via an opening in the U-shaped web to temporarily block the actuator. In this context, one corner of the U-shaped web usually ensures the temporary blocking of the actuator when the pin rests against it to switch off the electric motor.

This means that as soon as the pin has entered the relevant corner of the U-shaped web, this immediately leads to the actuator being blocked in its movement via the blocking element or the blocking lever. The same applies to the electric motor that drives the actuator. The resultant blocking of the electric motor leads to the switching off and subsequent reversal of the actuator, as already described.

For this purpose, the blocking element is equipped with an associated spring and in particular a tilting spring. The tilting spring supports the movement of the blocking element in the sense that when the actuator moves in the “unlock” direction, the blocking element swings its pin into the contour of the actuator and swings out again relative to the contour after the actuator movement is complete. For this purpose, the tilting spring in question is usually arranged on an additional spring arm of the blocking lever.

This means that the blocking lever typically has three arms, namely the blocking arm, which carries the pin, the control arm mentioned above and finally the spring arm to which the tilting spring is connected. The control arm supports the respective pivoting movement of the blocking element or blocking lever, both when pivoting the blocking lever in and out relative to the contour on the actuator.

The actual reversing process of the actuator following the actuator movement is usually initiated by means of a spring. For this purpose, the electromotive drive has the spring in question for reversing the actuator. The spring may be integrated into a gear box or otherwise into the electromotive drive with the electric motor.

As a result, a motor vehicle lock and in particular a motor vehicle door lock is provided and implemented which, first of all and in principle, opens up the possibility of being able to block the electromotive drive with electric motor, or the actuator acted on by it, in a simple manner directly and temporarily, i.e., for a limited period of time, namely with the aid of the blocking element or blocking lever. In this way, the electromotive drive can ultimately be used for at least two functions, namely, on the one hand, to transfer the coupling element of the operating lever chain selectively into the “engaged” and “disengaged” positions and, on the other hand, to be able to ensure that the locking mechanism is opened by an electric motor. These are the main advantages.

In the following, the invention is explained in more detail with the aid of a drawing showing only an exemplary embodiment; in the figures:

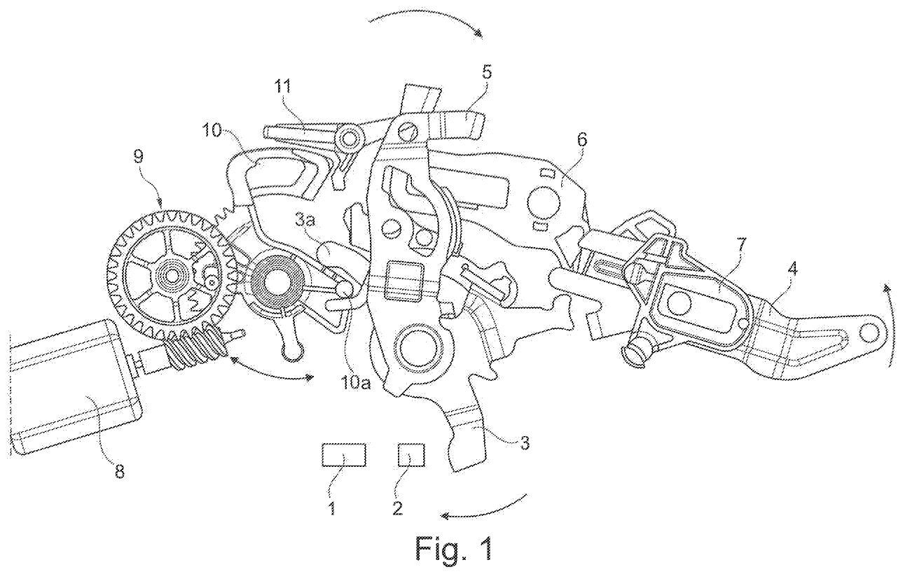

FIG. 1 shows the motor vehicle lock according to the invention in the form of a motor vehicle door lock, in a general and detailed overview,

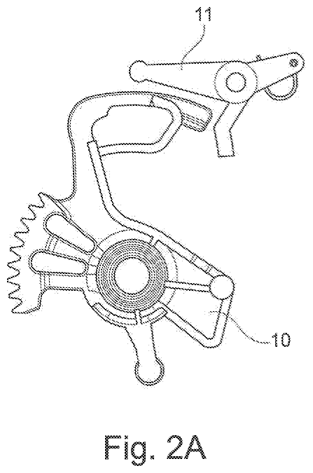

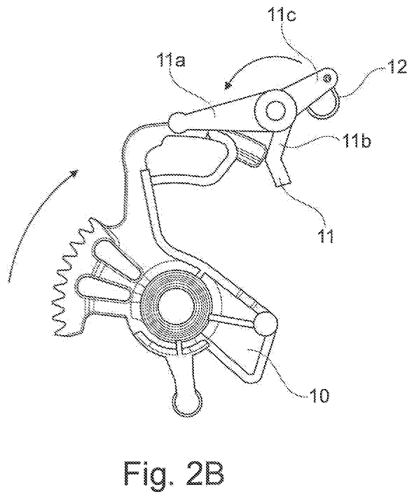

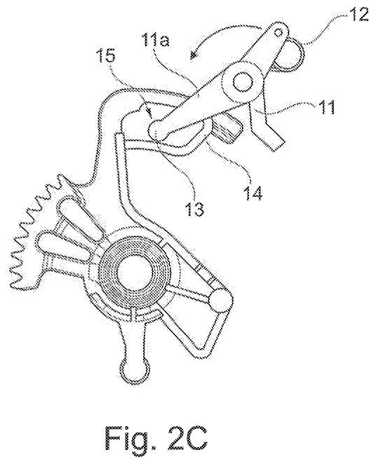

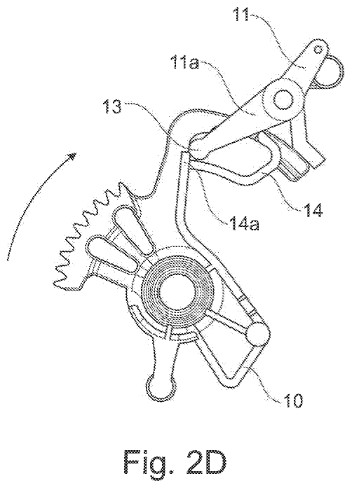

FIGS. 2A to 2D show the electromotive drive with actuator and blocking element in different functional positions during the transition from the “locked” initial position to the “unlocked” end positions in FIG. 2D,

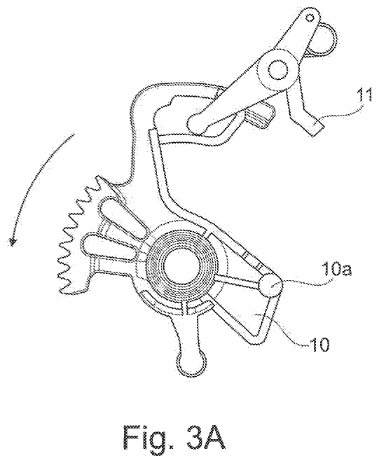

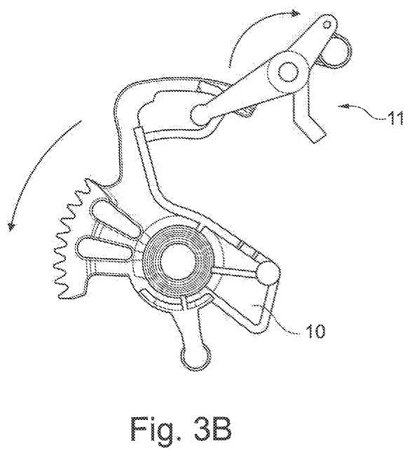

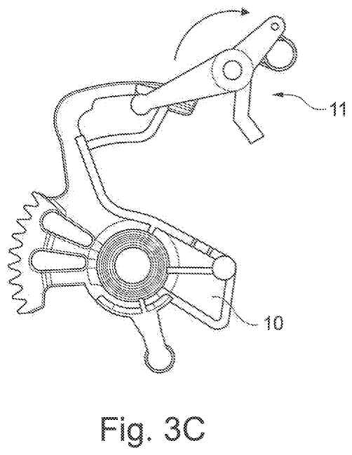

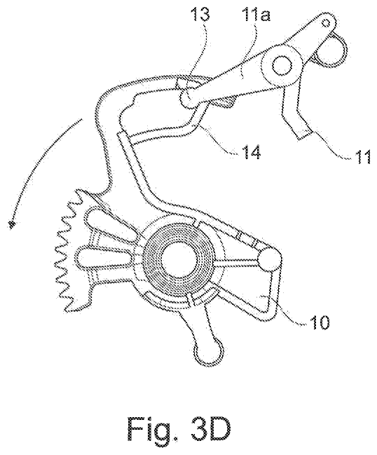

FIGS. 3A to 3D show the subject matter according to FIGS. 2A to 2D during a control element movement until the blocking of the electric motor in FIG. 3D, and

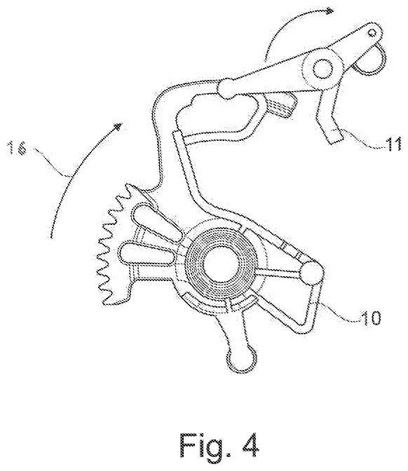

FIG. 4 shows the reversing process of the actuator and the pivoting out of the blocking element following the blocking position according to FIG. 3D in the transition to the initial position according to the illustration in FIG. 2A.

The drawings show a motor vehicle lock which, according to the exemplary embodiment, is a motor vehicle door lock. Said lock has a locking mechanism 1, 2, which is only indicated in FIG. 1, consisting essentially of a rotary latch 1 and a pawl 2. The rotary latch 1 and pawl 2 are shown in FIG. 1 only schematically in section, specifically in the closed state. To open the locking mechanism 1, 2, it is necessary for a release lever 3, also shown there, to perform a clockwise movement around its axis as indicated in FIG. 1.

The release lever 3 is part of an operating lever chain 3, 4, 5, 6, 7. In addition to the release lever 3, the operating lever chain 3, 4, 5, 6, 7 also includes an inner operating lever 4, an outer operating lever 5 and a transmission lever 6, which works on a coupling lever 7 or a coupling element 7, which according to the exemplary embodiment is designed as a coupling slide 7 mounted linearly on the inner operating lever 4.

The transmission lever 6 can be acted on by means of an electromotive drive 8, 9, 10. For this purpose, the electromotive drive 8, 9, 10 has an electric motor 8, a downstream gearbox 9 and an actuator 10, which can perform pivoting movements clockwise and counterclockwise about its axis, as indicated by a double arrow in FIG. 1. A blocking element 11, which is assigned to the actuator 10, is also essential for the following considerations.

According to the exemplary embodiment and not restrictively, the electromotive drive 8, 9, 10 is designed as a TCR drive and additionally or simultaneously as an electric motor opening drive. Of course, this is only by way of example and by no means mandatory. The electromotive drive 8, 9, 10 could just as well be used for other combined functions or positioning movements. The “TCR on” position corresponds to the fact that the transmission lever 6 does not act on the coupling element 7 or the coupling slide 7, so that the latter assumes an exposed position relative to the inner operating lever 4. This means that in this case the coupling slide 7 (supported by a spring) projects beyond the front side of the inner operating lever 4, so that a pivoting movement of the inner operating lever 4 in the anti-clockwise direction as indicated in FIG. 1 leads to the release lever 3 being able to be acted upon via the coupling element or the coupling slide 7 and performing the clockwise movement indicated in FIG. 1 in order to be able to open the locking mechanism 1, 2. However, this is not shown in detail.

This means that in the “TCR on” position of the electromotive drive 8, 9, 10, according to the embodiment, an emergency opening of the operating lever chain 3, 4, 5, 6, 7 or the locking mechanism 1, 2 acted upon thereby is possible. In principle, the electromotive drive 8, 9, 10 can also be referred to as a locking drive, which in the example described assumes its “unlocked” position or controls the operating lever chain 3, 4, 5, 6, 7 into the “unlocked” position by the electromotive drive 8, 9, 10 acting on the transmission lever 6 in such a way that the coupling element 7 assumes its “engaged” position. As mentioned, this is not reflected in FIG. 1. Here, the coupling element 7 assumes its exposed position relative to the inner operating lever 4.

Rather, FIG. 1 shows the functional state “TCR off” of the electromotive drive 8, 9, 10. In this state, the electromotive drive 8, 9, 10 urges the coupling element 7 against the force of the associated spring. Alternatively, it can also be said that the operating lever chain 3, 4, 5, 6, 7 is in its “locked” position and the coupling element 7 assumes its “disengaged” functional position. In this case, the transmission lever 6, against the force of the spring acting on the coupling element 7, ensures that the coupling element 7 assumes its retracted position shown in FIG. 1 in comparison to the inner operating lever 4. As a result, the counterclockwise movement of the inner operating lever 4 indicated in FIG. 1 does not lead to an opening of the locking mechanism 1, 2, because the inner operating lever 4 performs an idle movement relative to the release lever 3.

In contrast, the outer operating lever 5 is able to act on the release lever 3 and initiate the clockwise movement of the release lever 3 required to open the locking mechanism 1, 2 when pivoted clockwise about its axis common to the release lever 3, as also indicated in FIG. 1. The functionality described may be part of a “child protection” feature. Of course, other positions and functionalities are also conceivable.

According to the invention and of particular importance, the actuator 10 is now assigned not only the previously mentioned blocking element 11. Rather, the blocking element 11 overall ensures a temporary blocking of the actuator 10, as will be explained in greater detail below with reference to FIGS. 2A to 4. As a result of this blocking of the actuator 10 and thus also of the electric motor 8, the electric motor 8 is switched off because the electric motor 8 and consequently the electromotive drive 8, 9, 10 are acted upon by a control unit, not expressly shown, which detects an increased current consumption as a result of the blocking of the electric motor 8. This increased current consumption is interpreted as a blocking and causes the electric motor 8 to be switched off. Switching off the electric motor 8 now allows the actuator 10 to be reversed, as will be explained in greater detail below. This is because the switched-off electric motor 8 offers practically no mechanical resistance to such a reversing movement of the actuator 9, so that a spring 16, indicated only by an arrow in FIG. 4, as a component of the electromotive drive 8, 9, 10, ensures the desired reversing.

Starting now from the basic position of the motor vehicle lock as shown in FIG. 1, which is shown in FIG. 2A reduced to the actuator 10 and the blocking element 11, this includes the state as shown in FIG. 1, namely “TCR off” or “locked”. The coupling element 7 is therefore “disengaged” and the operating lever chain 3, 4, 5, 6, 7 is mechanically interrupted or open. This is ensured by the electromotive drive 8, 9, 10.

A priority of unlocking that can be understood during the transition from FIG. 2A to FIG. 2B now corresponds to the fact that the actuator 10, starting from the functional position in FIG. 2A, performs a counterclockwise movement as indicated in FIG. 2B. As a result, the blocking lever 11 pivots in the direction of the actuator 10. In fact, the blocking element 11 according to the exemplary embodiment is designed as a blocking lever with at least one blocking arm 11a and one control arm 11b. In addition and according to the exemplary embodiment, a spring arm 11c is also realized, on which a spring 12 and in particular a tilting spring 12 acts. Accordingly, the blocking element 11 is designed as a three-armed blocking lever 11.

Since the pivoting movement of the actuator 10 in the “unlocking” direction during the transition from FIG. 2A to the functional position of FIG. 2B is accompanied by the already described counterclockwise movement of the actuator 10, an edge of the actuator 10 can work on the control arm 11b and overall ensures that the blocking element or the blocking lever 11 is pivoted counterclockwise in the direction of the actuator 10 during this process. The actuator 10 may in turn and generally be acted upon by the force of a spring in the unlocking direction or—as in the exemplary embodiment—by a corresponding energization of the electric motor 8 as a component of the electromotive drive 8, 9, 10.

As the counterclockwise movement of the actuator 10 continues during the transition from FIG. 2B to FIG. 2C, the blocking arm 11a of the blocking element 11 finally dips, with a pin 13 provided at the end, into a blocking contour 14 of the actuator 10. The blocking contour 14 is a U-shaped web into which the pin 13 pivots via an opening 15 for temporarily blocking the actuator 10. It can be seen that the blocking element 11 is arranged overall adjacent to the blocking contour 14 or the U-shaped web 14.

During the transition from FIG. 2C to FIG. 2D, the pin 13 on the blocking arm 11a has finally reached a stop 14a of the U-shaped web 14, so that the actuator 10 has reached its end positions in the sense of “unlocked” or “TCR on” or “engaged” of the coupling element 7.

Following this “unlocked” state, which can also be detected by sensors and transmitted to the control unit, the control unit now ensures that the electromotive drive 8, 9, 10 is urged in the direction of the actuator movement, which will be examined in greater detail below, for the opening of the locking mechanism 1, 2 by an electric motor. As mentioned, the movement of the actuator 10 can be carried out in accordance with the sequence of FIGS. 2A to 2D, either spring-assisted or with the aid of the electromotive drive 8, 9, 10.

In any case, a comparison of FIGS. 2D and 3A shows that after reaching the “unlocked” position in FIG. 2D, the actuator 10 is urged in an anti-clockwise direction in order to open the locking mechanism 1, 2 by means of an electric motor. This is because a counterclockwise movement of the actuator 10 starting in the initial position according to FIG. 1 results in the actuator 10 moving to an actuating arm 3a of the release lever 3 via a pin 10a indicated there in FIG. 1 and thereby ensuring that the release lever 3 is pivoted in the clockwise direction indicated in FIG. 1 in order to be able to open the locking mechanism 1, 2.

The pivoting movement of the actuator 10 in the counterclockwise direction beginning in FIG. 3A now has the consequence that, during the transition to FIG. 3B, the blocking element or the blocking lever 11 is pivoted clockwise about its axis. During the further progressive movement of the actuator 10 in the counterclockwise direction about its axis, which is initiated by the action applied by the electromotive drive 8, 9, 10, it finally happens in the further sequence of figures according to FIGS. 3C and 3D that in the representation according to FIG. 3D the blocking arm 11a with the pin 13 arranged at its end reaches a corner of the contour or the U-shaped web 14. Now, the actuator 10 can no longer be pivoted counterclockwise around its axis by means of the electromotive drive 8, 9, 10, and the actuator 10 is blocked. The same applies for the electric motor 8.

Such a blocking of the actuator 10 is accompanied by an increased current increase for the electric motor 8, which can be detected by the control unit, not expressly shown, as an example. This increase in current is interpreted as a blocking of the electric motor 8 and causes the electric motor 8 to be switched off.

As a result, the actuator 10 can now be acted upon by means of the spring 16 already mentioned, namely in the sense of a pivoting movement in a clockwise direction about its axis, as indicated in FIG. 4 and an arrow therein. This is because the electric motor 8 or the electromotive drive 8, 9, 10 is switched off and cannot (any longer) act on the actuator 10, so that the latter can pivot more or less freely and only acted upon by the spring 12, namely in a clockwise direction.

This means that the actuator 10 has been temporarily blocked by means of the blocking element 11, namely when the pin 13 penetrates into the corner of the U-shaped web 14 on the actuator 10 and at this point ensures the temporary, i.e., time-limited, blocking of the actuator 10 and consequently of the electric motor 8.

Starting from FIG. 4 and the reversing movement of the actuator 10 indicated here by means of the spring 12 in a clockwise direction, the actuator 10 finally reaches its basic position again as shown in FIG. 2A and can therefore once again complete the actuating process already described above.

### LIST OF REFERENCE SIGNS

locking mechanism 1, 2
rotary latch 1
pawl 2
release lever 3
actuating arm 3a
operating lever chain 3, 4, 5, 6, 7
inner operating lever 4
outer operating lever 5
transmission lever 6
coupling lever/coupling element 7
electric motor 8
gearbox 9
actuator 10
pin 10a
drive 8, 9, 10
blocking element 11
blocking arm 11a
control arm 11b
spring arm 11c
tilting spring 12
pin 13
blocking contour 14
stop 14a
web 14
opening 15
spring 16

1. A motor vehicle lock comprising:
a locking mechanism including:
a rotary latch and
a pawl,
an operating lever chain including a coupling element,
a blocking element,
an actuator, and
an electromotive drive including an electric motor,
wherein, by the actuator, the electromotive drive is configured to selectively urge the coupling element of the operating lever chain into an engaged position and a disengaged position,
wherein the blocking element is configured to ensures temporary blocking of the actuator in order to switch off the electric motor following an actuator movement, and subsequent reversal of the actuator.

2. The motor vehicle lock according to claim 1, wherein the blocking element is rotatable about a first axis and the actuator is rotatable about a second axis, wherein the first and second axes run parallel to one another and are spaced apart from one another.

3. The motor vehicle lock according to claim 1, wherein the actuator includes a blocking contour, and wherein the blocking element is arranged adjacent to the blocking contour of the actuator.

4. The motor vehicle lock according to claim 3, wherein the blocking element is designed as a blocking lever including at least one blocking arm and a control arm.

5. The motor vehicle lock according to claim 4, wherein the blocking arm has a pin interacting with the blocking contour of the actuator.

6. The motor vehicle lock according to claim 5, wherein the blocking contour includes an opening and wherein the blocking contour is designed as a U-shaped web into which the pin pivots via the opening for temporarily blocking the actuator and thus the electric motor.

7. The motor vehicle lock according to claim 6, wherein the U-shaped web includes a corner, and wherein the corner of the U-shaped web ensures the temporary blocking of the actuator when the pin rests against the corner of the U-shaped web to switch off the electric motor.

8. The motor vehicle lock according to claim 4, wherein the blocking lever has an associated spring.

9. The motor vehicle lock according to claim 8, wherein the blocking lever further includes a spring arm, and wherein the spring is arranged on the spring arm of the blocking lever.

10. The motor vehicle lock according to claim 1, wherein the electromotive drive has a spring for reversing the actuator.

11. The motor vehicle lock according to claim 8, wherein the associated spring is tilting spring.

12. The motor vehicle lock according to claim 5, wherein the control arm is configured to support the blocking lever when pivoting the blocking lever in and out relative to the blocking contour of the actuator.

13. The motor vehicle lock according to claim 10, wherein the electromotive driver further includes a gear box, and wherein the spring for reversing the actuator is integrated into the gear box.

14. The motor vehicle lock according to claim 1, further comprising a sensor for detecting current consumption.

15. The motor vehicle lock according to claim 14, wherein the electric motor of the electromotive drive is in communication with the sensor to detect an increased current consumption of the electric motor during a blocking movement by the blocking element.
